(19) United States
(12) Patent Application Publication
(10) Pub. No.: US 2019/0309217 A1
(43) Pub. Date: Oct. 10, 2019

(54) AMARANTH GRAIN PARTICULATES FOR DIVERSION APPLICATIONS

(71) Applicant: Halliburton Energy Services, Inc., Houston, TX (US)

(72) Inventors: Prajakta Ratnakar Patil, Pune (IN); Mahesh Vijaykumar Biyani, Pune (IN); Shoy George Chittattukara, Thrissur (IN)

(73) Assignee: Halliburton Energy Services, Inc., Houston, TX (US)

(21) Appl. No.: 16/315,444

(22) PCT Filed: Aug. 4, 2016
(86) PCT No.: PCT/US2016/045638

§ 371 Date: Jan. 4, 2019

(51) Int. Cl. C09K 8/68; E21B 43/267; C09K 8/80

(52) U.S. Cl. CPC C09K 8/685; C09K 8/80; E21B 43/267

(57) ABSTRACT

Subterranean treatments are provided that use amaranth grain particulates for controlling flow of fluids in wellbore applications. A method for treating a wellbore may comprise providing a treatment fluid comprising a base fluid and amaranth grain particulates; and introducing the treatment fluid into a subterranean formation penetrated by the wellbore such that the amaranth grain particulates form a barrier to fluid flow in at least one flow path in the subterranean formation.

### BACKGROUND

Treatment fluids may be used in a variety of subterranean treatments, including, but not limited to, stimulation treatments. As used herein, the term “treatment” or “treating,” refers to any subterranean operation that uses a fluid in conjunction with a desired function and/or fbr a desired purpose. The terms “treatment,” and “treating,” as used herein, do not imply any particular action by the fluid or any particular component thereof. Examples of common subterranean treatments include, but are not limited to, drilling operations, fracturing operations (including prepad, pad and flush), perforation operations, sand control treatments (e.g., gravel packing, resin consolidation including the various stages such as preflush, afterflush, etc.), acidizing treatments (e.g., matrix acidizing or fracture acidizing), “frac-pack” treatments, cementing treatments, water control treatments, wellbore clean-out treatments, paraffin/wax treatments, scale treatments and “squeeze treatments.

In subterranean treatments, it is often desired to treat an interval of a subterranean formation having sections of varying permeability, reservoir pressures and/or varying degrees of formation damage, and thus may accept varying amounts of certain treatment fluids. For example, low reservoir pressure in certain areas of a subterranean fbrmation or a rock matrix or a proppant pack of high permeability may permit that portion to accept larger amounts of certain treatment fluids. It may be difficult to obtain a uniform distribution of the treatment fluid throughout the entire interval. For instance, the treatment fluid may preferentially enter portions of the interval with low fluid flow resistance at the expense of portions of the interval with higher fluid flow resistance. In some instances, these intervals with variable flow resistance may be water-producing intervals.

In conventional methods of treating such subterranean formations, once the less fluid flow-resistant portions of a subterranean formation have been treated, that area may, be sealed off using a variety of techniques to divert treatment fluids to more fluid flow-resistant portions of the interval. Such techniques may have involved, among other things, the injection of particulates, foams, emulsions, plugs, packers, or blocking polymers (e.g., crosslinked aqueous gels) into the interval so as to plug off high-permeability portions of the subterranean formation once they have been treated, thereby diverting subsequently injected fluids to more fluid flow-resistant portions of the subterranean formation.

In addition to diverting a treatment fluid in a subterranean formation, it may also be desirable to provide effective fluid loss control for subterranean treatment fluids. “Fluid loss,” as that term is used herein, refers to the undesirable migration or loss of fluids into a subterranean formation and/or a proppant pack. The term “proppant pack,” as used herein, refers to a collection of a mass of proppant particulates within a fracture or open space in a subterranean formation. Fluid loss may be problematic in any number of subterranean operations, including drilling operations, fracturing operations, acidizing operations, gravel-packing operations, wellbore clean-out operations, and the like. In fracturing treatments, for example, fluid loss into the formation may result in a reduction in fluid efficiency, such that the fracturing fluid cannot propagate the fracture as desired.

### BRIEF DESCRIPTION OF THE DRAWINGS

These drawings illustrate certain aspects of some of the embodiments of the present invention, and should not be used to limit or define the invention.

FIG. 1 is a schematic illustration of example well system showing placement of a treatment fluid into a wellbore.

FIGS. 2a and 2b are schematic illustrations showing use of amaranth grain particulates in an example fracturing treatment.

FIG. 3 is a particle size distribution curve for example amaranth grain particulates.

### DETAILED DESCRIPTION

The present disclosure is directed to subterranean treatments, and, at least in part, to using amaranth grain particulates for controlling flow of fluids in wellbore applications, such as in diversion applications. While the amaranth grain particulates may be suitable for use in a variety of wellbore applications where controlling fluid flow may be desired, they may be used, without limitation, for diversion applications in fracturing and/or acidizing treatments.

The subterranean treatments may include placing amaranth grain particulates into a subterranean formation. Without limitations, placing the amaranth grain particulates into the subterranean formation may include placement into a wellbore or into the region of the subterranean formation surrounding the wellbore. In the subterranean formation, the amaranth grain particulates particles may form a barrier to fluid flow. Without limitation, this barrier to fluid flow may be used for controlling fluid, for example, in diversion to divert treatment fluids to another area, or in fluid loss control to reduce leak off into the subterranean formation. Advantageously, the amaranth grain particulates may be degradable so that they can be easily removed from the subterranean formation to facilitate production, for example, without the needs for additional removal applications. Additionally, the amaranth grain particulates may be non-toxic and readily available in certain parts of the world, thus making their use less complex especially when compared to other diverting materials which may be difficult to obtain and expensive.

Amaranth grain particulates include particulates of amaranth grain derived from the aramanth family of plants. Amaranth grain is a grain that is used as a food crop in certain parts of the world. Amaranth grain may be referred to as rajgira. The aramanth family of plants includes any plant of the genus Amaranthacea, including, without limitation, Amaranthus caudatus, Amaranthus cruentus, and Amaranthus hypochondriacus. The aramanth family of plants also includes the goosefoot family (Chenopodiaceae), which includes beets and spinaches.

Without limitation, the amaranth grain particulates may be degradable. By way of example, the amaranth grain particulates may undergo an irreversible degradation downhole, in that they may not recrystallized or reconstitute downhole. The terms “degradation” and “degradable” may refer to either or both of heterogeneous degradation (or bulk erosion) and/or homogenous degradation (or surface erosion), and/or to any stage of degradation in between these two. This degradation can be the result of, inter alia, a chemical or thermal reaction or a reaction induced by radiation. Without being limited by theory, the rate and extent of degradation may be impacted by a number of factors, including the particular solvent, temperature, and pH, among others.

Without limitation, the size and/or shape of the amaranth grain particulates may be chosen so as to provide a barrier within a given flow path (e.g., within a point of entry into the wellbore and/or at a given distance from the wellbore within a fracture) having a given size, shape, and/or orientation. The amaranth grain particulates have a particle size of from about 0.001 mm to about 2 mm. As used herein, the term “particle size” refers to the d50 value. In addition, particle sizes outside this range may also be suitable, depending on the particular application. Without limitation, the degradable thermoplastic particulates may have a uni-modal or multi-modal particle size distribution. For example, multi-modal particle size distributions may enable formation of packs, bridges, or filter cakes in diversion applications to thereby obstruct fluid flow. The amaranth grain particulates may include whole amaranth grains, powered amaranth grains, partially crushed amaranth grains, and combinations therefore. Whole amaranth grains may have a particle size, for example, of from about 1 mm to about 2 mm. Partially crushed amaranth grains may have a particle size, for example, of from about 0.01 mm to about 0.5 mm. Powdered amaranth grains may have a particles size, for example, of from about 0.001 mm to about 0.005 mm. For example, the amaranth grain particulates may comprise whole amaranth grains having a particle size of from 1 mm to about 2 mm and powdered amaranth grains having a particle size of from about 0.001 mm to about 0.005 mm. By way of further example, the amaranth grain particulates may comprise partially crushed amaranth grains having a particle size of from 0.01 mm to about 0.5 mm and powdered amaranth grains having a particle size of from about 0.001 mm to about 0.005 mm. It should be understood that any of a variety of different techniques may be used to size the amaranth grains to provide amaranth grain particulates having a desired particle size distribution, including, but not limited to, sieving, mechanically sizing, cutting, or chopping. The term “particulate” is not intended to imply any particular shape for the amaranth grain particulates. Rather, the amaranth grain particulates may include, without limitation, amaranth grain having the physical shape of platelets, shavings, rods, flakes, ribbons, rods, strips, spheriods, toxoids, pellets, tablets, or any other physical shape.

The amaranth grain particulates may be included in a treatment fluid which may be placed downhole. Examples of treatment fluids include, but are not limited to, cement compositions, drilling fluids or muds, spacer fluids, lost circulation fluids, fracturing fluids, diverting fluids or completion fluids. Suitable treatments fluids may include, without limitation, an aqueous gel, a viscoelastic surfactant gel, an oil gel, a foamed gel, an emulsion, an inverse emulsion, a slickwater fluid, or combinations thereof. The treatment fluid may be for use in a wellbore that penetrates a subterranean formation. Without limitation, the amaranth grain particulates may be included in a treatment fluid in a concentration of about 0.01 pounds per gallon (“ppg”) to about 10 ppg or about 0.2 ppg to about 6 ppg. These ranges encompass every number in between, for example. For example, the concentration may range between about 0.5 ppg to about 4 ppg. One of ordinary skill in the art with the benefit of this disclosure should be able to select an appropriate amount of the amaranth grain particulates to use for a particular application.

The treatment fluid may comprise a base fluid and the amaranth grain particulates. Examples of suitable base fluids may be aqueous or non-aqueous. Suitable non-aqueous fluids may include one or more organic liquids, such as hydrocarbons (e.g., kerosene, xylene, toluene, or diesel), oils (e.g., mineral oils or synthetic oils), esters, and the like. Suitable aqueous base fluids may comprise, without limitation, freshwater, saltwater, brine, seawater, or any other suitable base fluids that preferably do not undesirably interact with the other components used in the treatment fluids. Generally, the base fluid may be present in the treatment fluids in an amount in the range of from about 45% to about 99.98% by volume of the treatment fluid. For example, the base fluid may be present in the treatment fluids in an amount in the range of from about 65% to about 75% by volume of the treatment fluid.

The treatment fluid may comprise any number of additional additives, including, but not limited to, salts, surfactants, acids, fluid loss control additives, gas, foamers, corrosion inhibitors, scale inhibitors, catalysts, clay control agents, biocides, friction reducing polymers, antifoam agents, bridging agents, dispersants, flocculants, H₂S scavengers, CO₂ scavengers, oxygen scavengers, lubricants, gelling agents, breakers, weighting agents, particulate materials (e.g., proppant particulates) and any combination thereof. With the benefit of this disclosure, one of ordinary skill in the art should be able to recognize and select suitable additives for use in the treatment fluid.

Optionally, proppant particulates may be included in the treatment fluid. For example, where the treatment fluid is a fracturing fluid, the treatment fluid may transport proppant particulates into the subterranean formation. Examples of suitable proppant particulates may include, without limitation, sand, bauxite, ceramic materials, glass materials, polymer materials, polytetrafluoroethylene materials, nut shell pieces, cured resinous particulates comprising nut shell pieces, seed shell pieces, cured resinous particulates comprising seed shell pieces, fruit pit pieces, cured resinous particulates comprising fruit pit pieces, wood, composite particulates, and combinations thereof. Suitable composite particulates may comprise a binder and a filler material wherein suitable filler materials include silica, alumina, fumed carbon, carbon black, graphite, mica, titanium dioxide, meta-silicate, calcium silicate, kaolin, talc, zirconia, boron, fly ash, hollow glass microspheres, solid glass, and combinations thereof. Without limitation, the proppant particulates may comprise graded sand. Other suitable proppant particulates that may be suitable for use in subterranean applications may also be useful. Without limitation, the proppant particulates may have a particle size in a range from about 2 mesh to about 400 mesh, U.S. Sieve Series. By way of example, the proppant particulates may have a particle size of about 10 mesh to about 70 mesh with distribution ranges of 10-20 mesh, 20-40 mesh, 40-60 mesh, or 50-70 mesh, depending, for example, on the particle sizes of the formation particulates to be screen out. The proppant particulates may be carried by the treatment fluid. Without limitation, the proppant particulates may be present in the treatment fluid in a concentration of about 0.1 pounds per gallon to about 10 ppg, about 0.2 ppg to about 6 ppg. These ranges encompass every number in between, for example. For example, the concentration may range between about 0.5 ppg to about 4 ppg. One of ordinary skill in the art with the benefit of this disclosure should be able to select an appropriate amount of the proppant particulates to use for a particular application.

Optionally, the treatment fluid may be an acidic treatment fluid. The treatment fluid may be an aqueous acid treatment fluid, for example, when used in acidizing treatments. By way of example, the treatment fluid may comprise one or more acids, including, but not limited to, mineral acids, such as hydrochloric acid and hydrofluoric acid, organic acids, such as acetic acid, formic acid, and other organic acids, or mixtures thereof. In acidizing treatments, mixtures of hydrochloric acid and hydrofluoric may be used, in some instances.

Optionally, the treatment fluid may comprise a friction reducing polymer. The friction reducing polymer may be included in the treatment fluid to form a slickwater fluid, for example. The friction reducing polymer may be a synthetic polymer. Additionally, for example, the friction reducing polymer may be an anionic polymer or a cationic polymer. By way of example, suitable synthetic polymers may comprise any of a variety of monomeric units, including acrylamide, acrylic acid, 2-acrylamido-2-methylpropane sulfonic acid, N,N-dimethylacrylamide, vinyl sulfonic acid, N-vinyl acetamide, N-vinyl formamide, itaconic acid, methacrylic acid, acrylic acid esters, methacrylic acid esters and combinations thereof. Without limitation, the friction reducing polymer may be included in the treatment fluid to provide a desired amount of friction reduction. For example, the friction reducing polymer may be included in the treatment fluid, for example, in an amount equal to or less than 0.2% by weight of an aqueous-based fluid present in the treatment fluid. Without limitation, the friction reducing polymer may be included in the treatment fluid in an amount sufficient to reduce friction without gel formation upon mixing. By way of example, the treatment fluid comprising the friction reducing polymer may not exhibit an apparent yield point.

Optionally, the treatment fluid may comprise a gelling agent. The friction reducing polymer may be included in the treatment fluid to form an aqueous gel, foamed gel, or oil gel, for example. Suitable gelling agents may comprise any polymeric material capable of increasing the viscosity of a base fluid, such as an aqueous fluid. Without limitation, the gelling agent may comprise polymers that have at least two molecules that may be capable of forming a crosslink in a crosslinking reaction in the presence of a crosslinking agent, and/or polymers that have at least two molecules that are so crosslinked (i.e., a crosslinked gelling agent). The gelling agents may be naturally-occurring, synthetic, or a combination thereof. Suitable gelling agents may comprise polysaccharides, and derivatives thereof that contain one or more of these monosaccharide units: galactose, mannose, glucoside, glucose, xylose, arabinose, fructose, glucuronic acid, or pyranosyl sulfate. Examples of suitable polysaccharides include, but are not limited to, guar gums (e.g., hydroxyethyl guar, hydroxypropyl guar, carboxymethyl guar, carboxymethylhydroxyethyl guar, and carboxymethylhydroxypropyl guar (“CMHPG”)), cellulose derivatives (e.g., hydroxyethyl cellulose, carboxyethylcellulose, carboxymethylcellulose, and carboxymethylhydroxyethylcellulose), and combinations thereof. The gelling agents comprise an organic carboxylated polymer, such as CMHPG. Additionally, polymers and copolymers that comprise one or more functional groups (e.g., hydroxyl, cis-hydroxyl, carboxylic acids, derivatives of carboxylic acids, sulfate, sulfonate, phosphate, phosphonate, amino, or amide groups) may be used. Where used, the gelling agent may be present in the treatment fluids in an amount sufficient to provide the desired viscosity. Without limitation, the gelling agents may be present in an amount in the range of from about 0.10% to about 10% by weight of the treatment fluid and, alternatively, from about 0.5% to about 4% by weight of the treatment fluid.

Optionally, a crosslinking agent may be included in the treatment fluids where it is desirable to crosslink the gelling agent. The crosslinking agent may comprise a metal ion that is capable of crosslinking at least two molecules of the gelling agent. Examples of suitable crosslinking agents include, but are not limited to, borate ions, zirconium IV ions, titanium IV ions, aluminum ions, antimony ions, chromium ions, iron ions, copper ions, and zinc ions. These ions may be provided by providing any compound that is capable of producing one or more of these ions; examples of such compounds include, but are not limited to, boric acid, disodium octaborate tetrahydrate, sodium diborate, pentaborates, ulexite, colemanite, zirconium lactate, zirconium triethanol amine, zirconium lactate triethanolamine, zirconium carbonate, zirconium acetylacetonate, zirconium maleate, zirconium citrate, zirconium diisopropylamine lactate, zirconium glycolate, zirconium triethanol amine glycolate, zirconium lactate glycolate, titanium lactate, titanium malate, titanium citrate, titanium ammonium lactate, titanium triethanolamine, and titanium acetylacetonate, aluminum lactate, aluminum citrate, antimony compounds, chromium compounds, iron compounds, copper compounds, zinc compounds, and combinations thereof. Without limitation, the crosslinking agent may be formulated to remain inactive until it is “activated” by, among other things, certain conditions in the fluid (e.g., pH, temperature, etc.) and/or contact with some other substance. Without limitation, the crosslinking agent may be delayed by encapsulation with a coating (e.g., a porous coating through which the crosslinking gent may diffuse slowly, or a degradable coating that degrades downhole) that delays the release of the crosslinking agent until a desired time or place. The choice of a particular crosslinking agent will be governed by several considerations that will be recognized by one skilled in the art, including but not limited to the following: the type of gelling agent included, the molecular weight of the gelling agent(s), the pH of the treatment fluid, temperature, and/or the desired time for the crosslinking agent to crosslink the gelling agent molecules.

Where used, suitable crosslinking agents may be present in the treatment fluids in an amount sufficient to provide, inter alis, the desired degree of crosslinking between molecules of the gelling agent. Without limitation, the crosslinking agent may be present in the treatment fluids of the present invention in an amount in the range of from about 0.0005% to about 0.2% by weight of the treatment fluid or alternatively from about 0.001% to about 0.05% by weight of the treatment fluid. One of ordinary skill in the art, with the benefit of this disclosure, should recognize the appropriate amount of crosslinking agent to include in a treatment fluid of the present invention based on, among other things, the temperature conditions of a particular application, the type of gelling agents used, the molecular weight of the gelling agents, the desired degree of viscosification, and/or the pH of the treatment fluid.

Optionally, the treatment fluid may further comprise a gel breaker, which may be useful for reducing the viscosity of the viscosified fracturing fluid at a specified time. A gel breaker may comprise any compound capable of lowering the viscosity of a viscosified fluid. The term “break” (and its derivatives) as used herein refers to a reduction in the viscosity of the viscosified treatment fluid, e.g., by the breaking or reversing of the crosslinks between polymer molecules or some reduction of the size of the gelling agent polymers. No particular mechanism is implied by the term. Suitable gel breaking agents for specific applications and gelled fluids are known to one skilled in the arts. Nonlimiting examples of suitable breakers include oxidizers, peroxides, enzymes, acids, and the like. Some viscosified fluids also may break with sufficient exposure of time and temperature.

Example methods of using the amaranth grain particulates will now be described in more detail. As previously described, the amaranth grain particulates may be placed in the subterranean formation such that a barrier to fluid flow may be formed. Without limitations, the amaranth grain particulates may form packs, bridges, filter cakes, or other suitable barriers to thereby obstruct fluid flow. Without limitation, this barrier to fluid flow may be used, for example, in diversion to divert treatment fluids to another area and in fluid loss control to reduce leak off into the subterranean formation. The fluid flow preventing barrier may be formed in the subterranean formation to block certain flow paths in the subterranean formation, reducing the flow of fluids through the subterranean formation. Examples of the types of flow paths that may be blocked by the fluid flow preventing barrier include, but are not limited to, perforations, such as those formed by a perforation gun, fissures, cracks, fractures, streaks, flow channels, voids, high permeable streaks, annular voids, or combinations thereof, as well as any other zone in the formation through which fluids may undesirably flow.

As will be appreciated by those of ordinary skill in the art, the amaranth grain particulates may be used in a variety of subterranean operations, where formation of a fluid flow diverting (or flow preventing) barrier may be desired, such as fluid diversion, and fluid loss control. Fluid diversion may be desired in a number of subterranean treatments, including fracturing and acidizing. Fluid loss control may be desired in a number of subterranean treatments, including, without limitation, drilling operations, fracturing operations, acidizing operations, and gravel packing operations. The amaranth grain particulates may be used prior to, during, or subsequent to a variety of subterranean operations. Methods of using the amaranth grain particulates may first include preparing a treatment fluid comprising the amaranth grain particulates. The treatment fluids may be prepared in any suitable manner, for example, by combining the amaranth grain particulates, base fluid, and any of the additional components described herein in any suitable order.

Methods may include introduction of the amaranth grain particulates into a subterranean formation. Introduction into the subterranean formation is intended to include introduction into a wellbore penetrating a subterranean formation, introduction into the zone(s) surrounding the wellbore, or both. A treatment fluid containing the amaranth grain particulates may dissipate into the subterranean formation through openings, which may be naturally occurring (e.g., pores, cracks, fractures, fissures, etc.) or man-made. As the treatment fluid dissipates into the subterranean formation, the amaranth grain particulates may be screened out by the formation, whereby the amaranth grain particulates may be packed into the openings. In the subterranean formation, the amaranth grain particulates form a flow preventing barrier that blocks certain flow paths therein, reducing the flow of fluids through the subterranean formation. Examples of the types of flow paths that may be blocked by the amaranth grain particulates include, but are not limited to, perforations, such as those formed by a perforation gun, fissures, cracks, fractures, streaks, flow channels, voids, high permeable streaks, annular voids, or combinations thereof, as well as any other zone in the formation through which fluids may undesirably flow. Methods may further include selecting one or more zones of the subterranean formation for control of fluid flow in which the amaranth grain particulates may be introduced.

The amaranth grain particulates may be used as diverting agents or fluid loss control agents, among others. Providing effective fluid loss control for subterranean treatment fluids is highly desirable. “Fluid loss,” as that term is used herein, refers to the undesirable migration or loss of fluids (such as the fluid portion of a drilling mud or cement slurry) into a subterranean formation and/or a proppant pack. Treatment fluids may be used in any number of subterranean operations, including drilling operations, fracturing operations, acidizing operations, gravel-packing operations, acidizing operations, well bore clean-out operations, and the like. Fluid loss may be problematic in any number of these operations. In fracturing treatments, for example, fluid loss into the formation may result in a reduction in fluid efficiency, such that the fracturing fluid cannot propagate the fracture as desired. Fluid loss control materials are additives that lower the volume of a filtrate that passes through a filter medium. That is, they block the pore throats and spaces that otherwise allow a treatment fluid to leak out of a desired zone and into an undesired zone. Particulate materials may be used as fluid loss control materials in subterranean treatment fluids to fill/bridge the pore spaces in a formation matrix and/or proppant pack and/or to contact the surface of a formation face and/or proppant pack, thereby forming a type of filter cake that blocks the pore spaces in the formation or proppant pack, and prevents fluid loss therein. Without limitation, when the amaranth grain particulates may be used as a fluid loss control agent, it may be used in conjunction with a fracturing or drilling operation. For example, the amaranth grain particulates may be included in a treatment fluid that is then placed into the portion of the subterranean formation at a pressure/rate sufficient to create or extend at least one fracture in that portion of the subterranean formation.

Diverting agents have similar actions but strive for a somewhat different approach. Diverting agents may be used to seal off a portion of the subterranean formation. By way of example, in order to divert a treatment fluid from permeable portions of the formation into the less permeable portions of the formation, a volume of treatment fluid may be pumped into the formation followed by amaranth grain particulates as a diverting agent to seal off a portion of the formation where the first treatment fluid penetrated. When desired for diversion, the amaranth grain particulates may be added to the first treatment fluid or a slug of another treatment fluid may be prepared that contains the amaranth grain particulates. After the amaranth grain particulates are placed, a second treatment fluid may be placed wherein the second treatment fluid will be diverted to a new zone for treatment by the previously placed diverting agent. When being placed, the treatment fluid containing the amaranth grain particulates will flow most readily into the portion of the formation having the largest pores, fissures, or vugs, until that portion is bridged and sealed, thus diverting the remaining fluid to the next most permeable portion of the formation. These steps may be repeated until the desired number of stages of treating fluid has been pumped. Without limitation, when used as diverting agents, the amaranth grain particulates may be included in treatment fluids introduced at matrix flow rates; that is, flow rates and pressures that are below the rate/pressure sufficient to create or extend fractures in that portion of a subterranean formation. Alternatively, the treatment fluids comprising the amaranth grain particulates may be introduced above the fracturing pressure of the subterranean formation.

As previously described, the amaranth grain particulates may be used as diverting agents in fracturing treatments. A method of fracturing a wellbore may comprise placing a fracturing fluid into a portion of a wellbore. The fracturing fluid may be used to create or extend one or more fractures in the subterranean formation. The fracturing fluid may enter flow paths to create one or more primary fractures extending from the wellbore into the subterranean formation. Branches may extend from the primary fractures. A fracturing fluid, commonly referred to as a pre-pad or pad fluid, may be injected to initiate the fracturing of a subterranean formation prior to the injection of proppant particulates. The pre-pad or pad fluid may be proppant-free or substantially proppant-free. The proppant particulates may be suspended in a fracturing fluid which may be injected into the subterranean formation to create and/or extend at least one fracture. In order to create and/or extend a fracture, a fluid is typically injected into the subterranean formation at a rate sufficient to generate a pressure above the fracturing pressure.

In the fracturing treatment, it may be desired to plug previously formed flow paths in order to fracture additional portions of the subterranean formation. The amaranth grain particulates may be introduced into the subterranean formation to form a barrier that restricts entry of additional fracturing fluid within the previously formed flow paths. An example method may include introducing a fracturing fluid into a subterranean at or above a fracturing pressure of the subterranean formation. The method may further include introducing amaranth grain particulates into the subterranean formation to thereby form a barrier that restricts fluid flow at a first location in the subterranean formation. The method may further include diverting the fracturing fluid to a second location in the subterranean formation. The amaranth grain particulates may be placed into the subterranean formation by forming a slug of a treatment fluid having a different composition than the fracturing fluid or by adding the amaranth grain particulates directly to the fracturing fluid, for example, creating a slug of the fracturing fluid comprising the amaranth grain particulates. The amaranth grain particulates may form a barrier at the first location to selectively place the fracturing fluid at one or more additional locations in the subterranean formation.

After a well treatment using the amaranth grain particulates, the wellbore and/or the subterranean formation may be prepared for production, for example, production of a hydrocarbon, therefrom. Preparing the wellbore and/or formation for production may comprise removing the amaranth grain particulates from one or more flow paths, for example, by allowing the amaranth grain particulates to degrade and subsequently recovering hydrocarbons from the formation via the wellbore. As previously described, the amaranth grain particulates may be degradable such that the barrier formed by the amaranth grain particulates may be remove. The degradable particles may be degraded by materials purposely placed in the formation by injection, mixing the degradable particle with delayed reaction degradation agents, or other suitable means to induce degradation.

Removal of the amaranth grain particulates, if desired, may be effected by any number of suitable treatments. By way of example, the amaranth grain particulates may be removed by acid hydrolysis and/or by contact with oxidizers. Removal may include contacting the amaranth grain particulates with an oxidizer, such as persulfate, alkali metal chlorite or hypochlorite, peroxides, ammonium or metal chlorate, bromate, iodates or perchlorate, perbromate, periodate. Without limitation, specific examples of suitable oxidizers may include sodium persulfate, ammonium persulfate, potassium persulfate, lithium hypochlorite, or sodium hypochlorite, calcium hypochlorite, sodium chlorate, sodium bromate, sodium iodate, sodium perchlorate, sodium perbromate, sodium periodate, potassium chlorate, potassium bromate, potassium iodate, potassium perchlorate, potassium perbromate, potassium periodate, ammonium chlorate, ammonium bromate, ammonium iodate, ammonium perchlorate, ammonium perbromate, ammonium periodate, magnesium chlorate, magnesium bromate, magnesium iodate, magnesium perchlorate, magnesium perbromate, magnesium periodate, zinc chlorate, zinc bromate, zinc iodate, zinc perchlorate, zinc perbromate, zinc periodate, sodium perborate, t-butyl hydroperoxide, or combinations thereof. The oxidizer may be introduced into the formation by way of the wellbore. Without limitation, the amaranth grain particulates may be susceptible to hydrolysis by acids so the modified biopolymer may be contacted by an acid in the subterranean formation, for example, to break down the amaranth grain particulates.

Accordingly, this disclosure describes systems, compositions, and methods that may use amaranth grain particulates for diversion, fluid loss control, and/or other subterranean treatments for controlling fluid flow in subterranean formations. Without limitation, the systems, compositions, and methods may include any of the following statements:

Statement 1: A method for treating a wellbore, comprising: providing a treatment fluid comprising a base fluid and amaranth grain particulates; and introducing the treatment fluid into a subterranean formation penetrated by the wellbore such that the amaranth grain particulates form a barrier to fluid flow in at least one flow path in the subterranean formation.

Statement 2: The method of statement 1, further comprising diverting the flow of a second treatment fluid from the at least one flow path to one or more additional flow paths in the subterranean formation.

Statement 3: The method of statement 1 or 2, further comprising further comprising fracturing the subterranean formation with a fracturing fluid to create or enhance at least one fracture in the subterranean formation prior to the step of introducing the treatment fluid, and fracturing the subterranean formation with the fracturing fluid to create or enhance one or more additional fractures in the subterranean formation, wherein the barrier diverts the fracturing fluid away from the at least one flow path.

Statement 4: The method any one of statements 1 to 3, further comprising adding the amaranth grain particulates to the fracturing fluid to form the treatment fluid.

Statement 5: The method of any one of statements 1 to 4, degrading at least a portion of the amaranth grain particulates to remove the barrier.

Statement 6: The method of statement 5, wherein the degrading comprising contacting the amaranth grain particulates with an acid, an oxidizer, or combination thereof.

Statement 7: The method of any one of statements 1 to 6, wherein the amaranth grain particulates are present in the treatment fluid in a concentration of about 0.01 pounds per gallon to about 10 pounds per gallon.

Statement 8: The method of any one of statements 1 to 7, wherein the amaranth grain particulates comprise a first portion of particulates having a particle size of about 1 millimeters to about 2 millimeters and a second portion of particulates having a particle size of about 0.001 millimeters to about 0.005 millimeters.

Statement 9: The method of any one of statements 1 to 7, wherein the amaranth grain particulates comprise a first portion of particulates having a particle size of about 0.01 millimeters to about 0.5 millimeters and a second portion of particulates having a particle size of about 0.001 millimeters to about 0.005 millimeters.

Statement 10: The method of any one of statements 1 to 9, wherein the treatment fluid further comprises an acid.

Statement 11: The method of any one of statements 1 to 10, wherein the treatment fluid is a linear or crosslinked gel.

Statement 12: A treatment fluid comprising: a base fluid; and amaranth grain particulates.

Statement 13: The treatment fluid of statement 12, wherein the amaranth grain particulates are present in the treatment fluid in a concentration of about 0.01 pounds per gallon to about 10 pounds per gallon.

Statement 14: The treatment fluid of statement 12 or 13, wherein the amaranth grain particulates comprise a first portion of particulates having a particle size of about 1 millimeters to about 2 millimeters and a second portion of particulates having a particle size of about 0.001 millimeters to about 0.005 millimeters.

Statement 15: The treatment fluid of statement 12 or 13, wherein the amaranth grain particulates comprise a first portion of particulates having a particle size of about 0.01 millimeters to about 0.5 millimeters and a second portion of particulates having a particle size of about 0.001 millimeters to about 0.005 millimeters.

Statement 16: The treatment fluid of any one of statements 12 to 14, wherein the treatment fluid further comprises an acid.

Statement 17: The treatment fluid of any one of statements 12 to 15 wherein the treatment fluid is a linear or crosslinked gel.

Statement 18: A well system comprising: a treatment fluid comprising a base fluid and amaranth grain particulates; fluid handling system comprising the treatment fluid; and a conduit fluidically coupled to the fluid handling system and a wellbore.

Statement 19: The well system of statement 18, wherein the fluid handling system comprises a fluid supply and pumping equipment.

Statement 20: The well system of statement 18 or 19, wherein the amaranth grain particulates comprise a first portion of particulates having a particle size of about 1 millimeters to about 2 millimeters and a second portion of particulates having a particle size of about 0.001 millimeters to about 0.005 millimeters.

Statement 21: The well system of statement 18 or 19, wherein the amaranth grain particulates comprise a first portion of particulates having a particle size of about 0.01 millimeters to about 0.5 millimeters and a second portion of particulates having a particle size of about 0.001 millimeters to about 0.005 millimeters.

Statement 22: The well system of any one of statements 18 to 21 further comprising one or more of the features defined in any one of statements 7, 10, or 11.

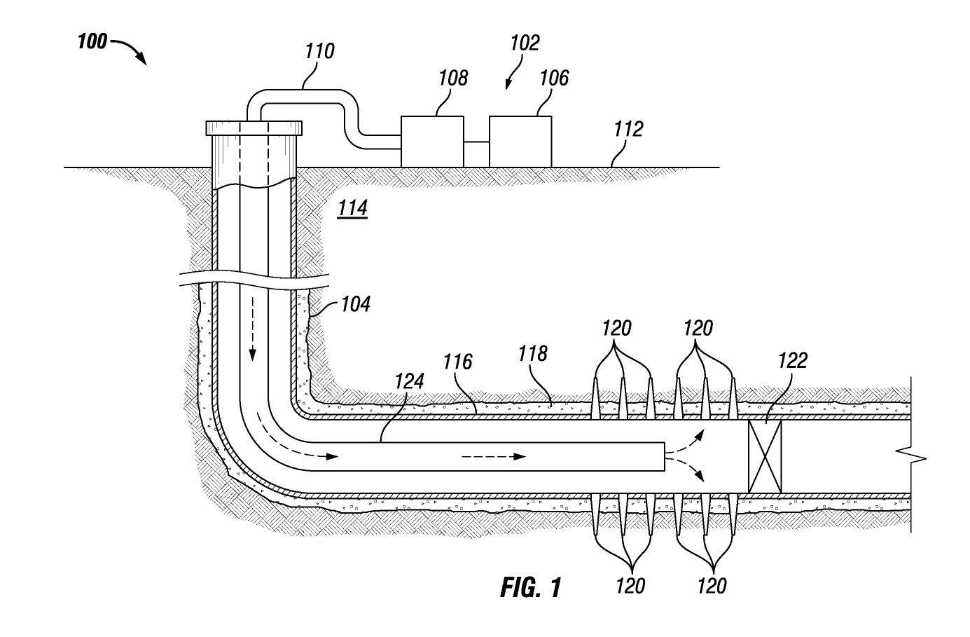

Example methods of using the amaranth grain particulates will now be described in more detail with reference to FIG. 1. Any of the previous examples of the amaranth grain particulates may apply in the context of FIG. 1. FIG. 1 illustrates an example well system 100 that may be used for preparation and delivery of a treatment fluid downhole. It should be noted that while FIG. 1 generally depicts a land-based operation, those skilled in the art will readily recognize that the principles described herein are equally applicable to subsea operations that employ floating or sea-based platforms and rigs, without departing from the scope of the disclosure.

Referring now to FIG. 1, a fluid handling system 102 is illustrated. The fluid handling system 102 may be used for preparation of a treatment fluid comprising amaranth grain particulates and for introduction of the treatment fluid into a wellbore 104. The fluid handling system 102 may include mobile vehicles, immobile installations, skids, hoses, tubes, fluid tanks or reservoirs, pumps, valves, and/or other suitable structures and equipment. As illustrated, the fluid handling system 102 may comprise a fluid supply vessel 106, pumping equipment 108, and wellbore supply conduit 110. While not illustrated, the fluid supply vessel 106 may contain one or more components of the treatment fluid (e.g., amaranth grain particulates, base fluid, etc.) in separate tanks or other containers that may be mixed at any desired time. Pumping equipment 108 may be fluidically coupled with the fluid supply vessel 106 and wellbore supply conduit 110 to communicate the treatment fluid into wellbore 104. Fluid handling system 102 may also include surface and downhole sensors (not shown) to measure pressure, rate, temperature and/or other parameters of treatment. Fluid handling system 102 may also include pump controls and/or other types of controls for starting, stopping, and/or otherwise controlling pumping as well as controls for selecting and/or otherwise controlling fluids pumped during the injection treatment. An injection control system may communicate with such equipment to monitor and control the injection of the treatment fluid. As depicted in FIG. 1, the fluid supply vessel 106 and pumping equipment 108 may be above the surface 112 while the wellbore 104 is below the surface 112. As will be appreciated by those of ordinary skill in the art, well system 100 may be configured as shown in FIG. 1 or in a different manner, and may include additional or different features as appropriate. By way of example, fluid handling system 102 may be deployed via skid equipment, marine vessel, or may be comprised of sub-sea deployed equipment.

Without continued reference to FIG. 1, well system 100 may be used for introduction of a treatment fluid into wellbore 104. The treatment fluid may contain a base fluid (which may be oil- or aqueous-based) and amaranth grain particulates, described herein. Generally, wellbore 104 may include horizontal, vertical, slanted, curved, and other types of wellbore geometries and orientations. Without limitation, the treatment fluid may be applied through the wellbore 104 to subterranean formation 114 surrounding any portion of wellbore 104. As illustrated, the wellbore 104 may include a casing 116 that may be cemented (or otherwise secured) to wellbore wall by cement sheath 118. Perforations 120 allow the treatment fluid and/or other materials to flow into and out of the subterranean formation 114. A plug 122, which may be any type of plug (e.g., bridge plug, etc.) may be disposed in wellbore 104 below the perforations 120 if desired. While FIG. 1 illustrates used of treatment fluid in a cased section of wellbore 104, it should be understood that treatment fluid may also be used in portions of wellbore 104 that are not cased.

The treatment fluid comprising the amaranth grain particulates may be pumped from fluid handling system 102 down the interior of casing 116 in wellbore 104. As illustrated, well conduit 124 (e.g., coiled tubing, drill pipe, etc.) may be disposed in casing 116 through which the treatment fluid may be pumped. The well conduit 124 may be the same or different than the wellbore supply conduit 110. For example, the well conduit 124 may be an extension of the wellbore supply conduit 110 into the wellbore 104 or may be tubing or other conduit that is coupled to the wellbore supply conduit 110. The treatment fluid may be allowed to flow down the interior of well conduit 124, exit the well conduit 124, and finally enter subterranean formation 114 surrounding wellbore 104 by way of perforations 120 through the casing 116 (if the wellbore is cased as in FIG. 1) and cement sheath 118. Without limitation, the treatment fluid may be introduced into subterranean formation 114 whereby one or more fractures (not shown) may be created or enhanced in subterranean formation 114. For example, the treatment fluid may be introduced into subterranean formation 114 at or above a fracturing pressure. As previously, described, the treatment fluid comprising the amaranth grain particulates may be placed into the subterranean 114 after a previous treatment has been performed such that additional locations in the subterranean formation 114 may be treated. Without limitation, at least a portion of the amaranth grain particulates may be deposited in the subterranean formation 114. As previously described, the amaranth grain particulates may form a barrier to fluid flow in the subterranean formation.

As previously described, a variety of treatments may be performed using the amaranth grain particulates. Suitable subterranean treatments may include, but are not limited to, drilling operations, production stimulation operations (e.g., fracturing, acidizing), and well completion operations (e.g., gravel packing or cementing). These treatments may generally be applied to the subterranean formation. The barrier to fluid flow formed in the subterranean formation 114 by the amaranth grain particulates may be used in these treatments for diversion and fluid loss control, among others. For example, the diversion of the treatment fluids may help ensure that the treatment fluids are more uniformly distributed in the subterranean formation.

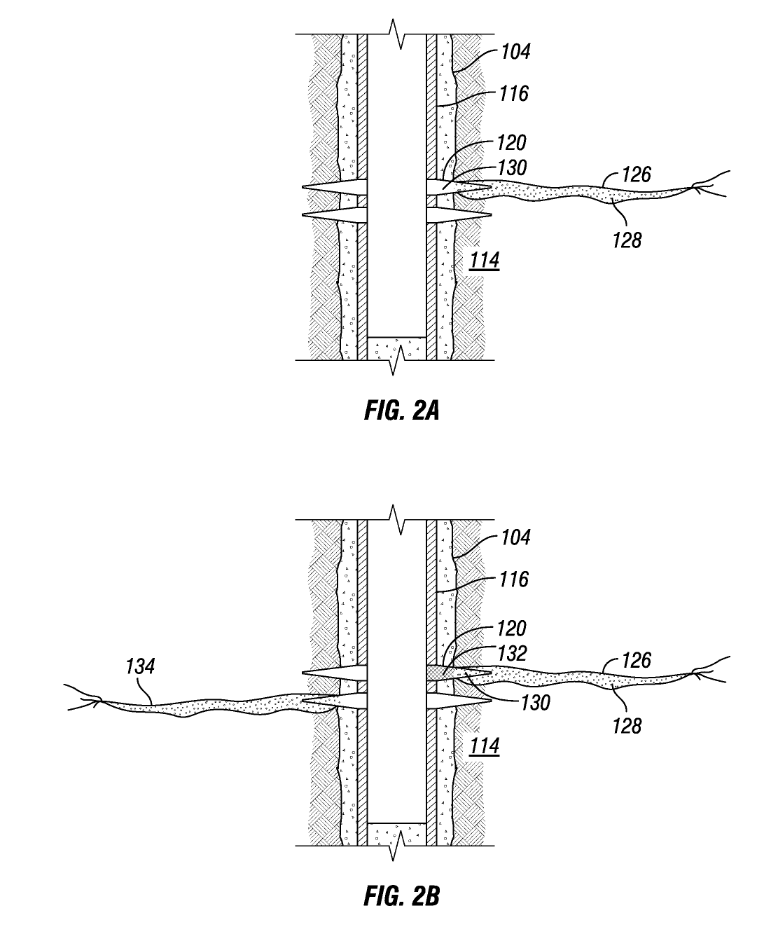

The well treatment may comprise a fracturing treatment in which one or more fractures may be created in subterranean formation 114. Referring now to FIG. 2A, fracture 126 is shown extending from wellbore 104. The fracturing of the subterranean formation 114 may be accomplished using any suitable technique. By way of example, a fracturing treatment may include introducing a fracturing fluid into subterranean formation 114 at or above a fracturing pressure. The fracturing fluid may be introduced by pumping the fracturing fluid through casing 116, perforations 120, and into subterranean formation 114 surrounding wellbore 104. Alternatively, a jetting tool (now shown) may be used to initiate the fracture 126. The fracturing fluid may comprise proppant particulates which may be deposited on the fracture 126 to form a proppant pack 128.

To form a barrier that can divert the fracturing fluid to additional flow paths, the amaranth grain particulates may be introduced into the subterranean formation 114. The amaranth grain particulates may be carried into the subterranean formation 114 in a treatment fluid. The amaranth grain particulates may be introduced through the perforation 120 and into a perforation tunnel 130. Without limitation, the treatment fluid comprising the amaranth grain particulates may be a slug of the fracturing fluid comprising the amaranth grain particulates or a separate treatment fluid comprising the amaranth grain particulates. The treatment fluid comprising the amaranth grain particulates may be introduced above the fracturing pressure or at matrix flow rates. Without limitation, the proppant pack 128 may act as a filter screening the amaranth grain particulates out of the treatment fluid. As a result, a layer or pack of the amaranth grain particulates may form on the proppant particulates, in the perforation tunnel 130, or both. As shown in FIG. 2B, a barrier 132 comprising the amaranth grain particulates may be formed in the perforation tunnel 130. The resulting barrier 132 may be able to divert fluids away from fracture 126. Such diversion may result in a back pressure build up that may be detected at surface 112 (e.g., shown on FIG. 1). After formation of the barrier 132, additional subterranean treatments may be performed. As shown on FIG. 2B, additional fracture 134 may be created in subterranean formation 114. Additional fracture 134 may be formed, for example, in a portion of subterranean formation 114 with least resistance to fluid flow, as barrier 132 has diverted the fracturing fluid into additional portions of the subterranean formation 114 in which treatment may be desired.

The exemplary amaranth grain particulates disclosed herein may directly or indirectly affect one or more components or pieces of equipment associated with the preparation, delivery, recapture, recycling, reuse, and/or disposal of the amaranth grain particulates. For example, the amaranth grain particulates may directly or indirectly affect one or more mixers, related mixing equipment, mud pits, storage facilities or units, composition separators, heat exchangers, sensors, gauges, pumps, compressors, and the like used generate, store, monitor, regulate, and/or recondition the sealant composition. The amaranth grain particulates may also directly or indirectly affect any transport or delivery equipment used to convey the amaranth grain particulates to a well site or downhole such as, for example, any transport vessels, conduits, pipelines, trucks, tubulars, and/or pipes used to compositionally move the amaranth grain particulates from one location to another, any pumps, compressors, or motors (e.g., topside or downhole) used to drive the amaranth grain particulates into motion, any valves or related joints used to regulate the pressure or flow rate of the amaranth grain particulates (or fluids containing the same amaranth grain particulates), and any sensors (i.e., pressure and temperature), gauges, and/or combinations thereof, and the like. The disclosed amaranth grain particulates may also directly or indirectly affect the various downhole equipment and tools that may come into contact with the amaranth grain particulates such as, but not limited to, wellbore casing, wellbore liner, completion string, insert strings, drill string, coiled tubing, slickline, wireline, drill pipe, drill collars, mud motors, downhole motors and/or pumps, cement pumps, surface-mounted motors and/or pumps, centralizers, turbolizers, scratchers, floats (e.g., shoes, collars, valves, etc.), logging tools and related telemetry equipment, actuators (e.g., electromechanical devices, hydromechanical devices, etc.), sliding sleeves, production sleeves, plugs, screens, filters, flow control devices (e.g., inflow control devices, autonomous inflow control devices, outflow control devices, etc.), couplings (e.g., electro-hydraulic wet connect, dry connect, inductive coupler, etc.), control lines (e.g., electrical, fiber optic, hydraulic, etc.), surveillance lines, drill bits and reamers, sensors or distributed sensors, downhole heat exchangers, valves and corresponding actuation devices, tool seals, packers, cement plugs, bridge plugs, and other wellbore isolation devices, or components, and the like.

To facilitate a better understanding of the present disclosure, the following examples of certain aspects of some of the systems and methods are given. In no way should the following examples be read to limit, or define, the entire scope of the disclosure.

### Example 1

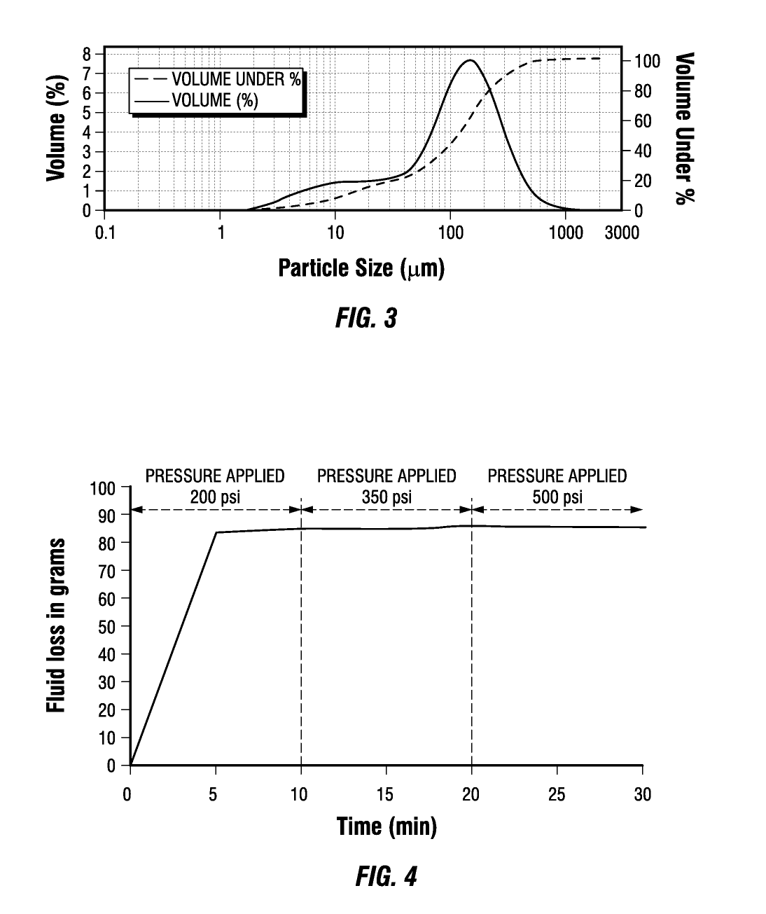

An API High Pressure High Temperature (“HPHT”) fluid loss test was performed using amaranth grain particulates. For selection of the ceramic disc used in the HPHT fluid loss test, particulate size distribution tests were performed on the amaranth grain particulates. A particle size distribution curve for the amaranth grain particulates used in this Example is provided in FIG. 3. Table 1 below provides a summary of the particle size distribution analysis.

TABLE 1
Summary of Particle Size Distribution Analysis

| | Particle Size |
|---|---|
| D10 | 12.08 microns |
| D50 | 114.43 microns |
| D90 | 289.70 microns |

For the API HPHT fluid loss test, 500 milliliters of a linear gel was prepared. The linear gel comprised 30 pounds per thousand gallons of a guar-based gelling agent in tap water. In a Waring blender, 10 grams of the amaranth grain particulates were added to the linear gel. The liner gel was the stirred for about 2-3 minutes at 1600-1700 rotations per minute to ensure suspension of the amaranth grain particulates. The linear gel was then loaded in the test cell for the static fluid loss test. The static fluid loss test was performed at room temperature and at a differential pressure up to 500 pounds per square inch (psi) using 40-micron ceramic discs. The results of the tests are provided in FIG. 4. The results are provided as fluid loss with time. As illustrated, 200 psi of pressure was applied for 10 minutes, followed by 350 psi of pressure for 10 minutes, followed by 500 psi of pressure for 10 minutes.

As illustrated by FIG. 4, the linear gel with the amaranth grain particulates formed a suitable filter cake in just 2 minutes. It can also be inferred that with the 40-micron ceramic disc, a completely impermeably filter cake was formed after a loss of approximately 86.32 grams of fluid (i.e., only 17.27% of fluid loss), thus confirming the filter cake forming capability of amaranth grain particulates. The thickness of the filter cake after the fluid loss tests was approximately 2 millimeters.

### Example 2

The degradation of amaranth grain particulates in an acidic medium (i.e., hydrochloric acid) was also examined. The degradation of amaranth grain particulates was examined by adding 1 gram of amaranth grain particulates to 5%, 10%, and 15% hydrochloric acid for a period of 6 hours at 167° F. The amount of residue left after the 6-hour period was calculated by filtering the residue from the acidic medium. Whatman No. 41 filter paper was used for filtering the residue. The results showed that about 90% of the amaranth grain particulates were degraded in the 6-hour period with 5% hydrochloric acid, and the degradation was even more pronounced as the acid concentration increased. The results of this Example are provided in Table 2 below.

TABLE 2
Degradation of Amaranth Grain Particulates in Acid

| | Initial Weight | Residue Weight | % Degradation |
|---|---|---|---|
| HCl Concentration | After 6 Hours | After 6 Hours | After 6 Hours |
| 5% | 1 g | 0.11 g | 89% |
| 10% | 1 g | 0.07 g | 93% |
| 15% | 1 g | 0.05 g | 95% |

### Example 3

The degradation of amaranth grain particulates in a neutral medium was also examined. For this Example, 1 gram of amaranth grain particulates was added to 100 milliliters of water to which 2 gallons per thousand gallons (“gpt”) a sodium chlorite oxidizing breaker was added. The fluid was then kept at two different temperatures (150° F. and 200° F.) for a period of 5 hours. The amount of residue left after the 5-hour period was calculated by filtering the residue from the water. Whatman No. 41 filter paper was used for filtering the residue. The results shows that about 65% of the amaranth grain particulates were degraded at 150° F. and about 74% of the amaranth grain particulates were degraded at 200° F. The results of this Example are provided in Table 3 below.

TABLE 3
Degradation of Amaranth Grain Particulates with Breaker

| | Sodium | | Residue | |
|---|---|---|---|---|
| | Chlorite | Initial Weight | Weight After 5 | % Degradation |
| Temperature | Breaker | After 5 Hours | Hours | After 5 Hours |
| 150° F. | 2 gpt | 1 g | 0.35 g | 65% |
| 200° F. | 2 gpt | 1 g | 0.26 | 74% |

It should be understood that the compositions and methods are described in terms of “comprising,” “containing,” or “including” various components or steps, the compositions and methods can also “consist essentially of or” consist of the various components and steps. Moreover, the indefinite articles “a” or “an,” as used in the claims, are defined herein to mean one or more than one of the element that it introduces.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Although individual embodiments are discussed, the invention covers all combinations of all those embodiments. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative embodiments disclosed above may be altered or modified and all such variations are considered within the scope and spirit of the present invention. If there is any conflict in the usages of a word or term in this specification and one or more patent(s) or other documents that may be incorporated herein by reference, the definitions that are consistent with this specification should be adopted.

What is claimed is:

1. A method for treating a wellbore, comprising:
providing a treatment fluid comprising a base fluid and amaranth grain particulates; and
introducing the treatment fluid into a subterranean formation penetrated by the wellbore such that the amaranth grain particulates form a barrier to fluid flow in at least one flow path in the subterranean formation.

2. The method of claim 1, further comprising diverting the flow of a second treatment fluid from the at least one flow path to one or more additional flow paths in the subterranean formation.

3. The method of claim 1, further comprising fracturing the subterranean formation with a fracturing fluid to create or enhance at least one fracture in the subterranean formation prior to the step of introducing the treatment fluid, and fracturing the subterranean formation with the fracturing fluid to create or enhance one or more additional fractures in the subterranean formation, wherein the barrier diverts the fracturing fluid away from the at least one flow path.

4. The method claim 3, further comprising adding the amaranth grain particulates to the fracturing fluid to form the treatment fluid.

5. The method of claim 1, degrading at least a portion of the amaranth grain particulates to remove the barrier.

6. The method of claim 5, wherein the degrading comprising contacting the amaranth grain particulates with an acid, an oxidizer, or combination thereof.

7. The method of claim 1, wherein the amaranth grain particulates are present in the treatment fluid in a concentration of about 0.01 pounds per gallon to about 10 pounds per gallon.

8. The method of claim 1, wherein the amaranth grain particulates comprise a first portion of particulates having a particle size of about 1 millimeters to about 2 millimeters and a second portion of particulates having a particle size of about 0.001 millimeters to about 0.005 millimeters.

9. The method of claim 1, wherein the amaranth grain particulates comprise a first portion of particulates having a particle size of about 0.01 millimeters to about 0.5 millimeters and a second portion of particulates having a particle size of about 0.001 millimeters to about 0.005 millimeters.

10. The method of claim 1, wherein the treatment fluid further comprises an acid.

11. The method of claim 1, wherein the treatment fluid is a linear or crosslinked gel.

12. A treatment fluid comprising:
a base fluid; and
amaranth grain particulates.

13. The treatment fluid of claim 12, wherein the amaranth grain particulates are present in the treatment fluid in a concentration of about 0.01 pounds per gallon to about 10 pounds per gallon.

14. The treatment fluid of claim 12, wherein the amaranth grain particulates comprise a first portion of particulates having a particle size of about 1 millimeters to about 2 millimeters and a second portion of particulates having a particle size of about 0.001 millimeters to about 0.005 millimeters.

15. The treatment fluid of claim 12, wherein the amaranth grain particulates comprise a first portion of particulates having a particle size of about 0.01 millimeters to about 0.5 millimeters and a second portion of particulates having a particle size of about 0.001 millimeters to about 0.005 millimeters.

16. The treatment fluid of claim 11, wherein the treatment fluid further comprises an acid.

17. A well system comprising:
a treatment fluid comprising a base fluid and amaranth grain particulates;
a fluid handling system comprising the treatment fluid; and
a conduit fluidically coupled to the fluid handling system and a wellbore.

18. The well system of claim 17, wherein the fluid handling system comprises a fluid supply and pumping equipment.

19. The well system of claim 17, wherein the amaranth grain particulates comprise a first portion of particulates having a particle size of about 1 millimeters to about 2 millimeters and a second portion of particulates having a particle size of about 0.001 millimeters to about 0.005 millimeters.

20. The well system of claim 17, wherein the amaranth grain particulates comprise a first portion of particulates having a particle size of about 0.01 millimeters to about 0.5 millimeters and a second portion of particulates having a particle size of about 0.001 millimeters to about 0.005 millimeters.
